(19) United States
(12) Patent Application Publication
(10) Pub. No.: US 2012/0072617 A1
(43) Pub. Date: Mar. 22, 2012

(54) Electronic Device, Control Method for an Electronic Device, and Recording Medium Storing a Program Executed by a Control Unit that Controls the Electronic Device

(75) Inventors: Masayo Miyasaka, Nagano-ken (JP); Shinichi Yoshie, Nagano-ken (JP)

(73) Assignee: SEIKO EPSON CORPORATION, Tokyo (JP)

(21) Appl. No.: 13/224,195

(22) Filed: Sep. 1, 2011

(30) Foreign Application Priority Data
Sep. 16, 2010 (JP) 2010-207745

(51) Int. Cl. G06F 3/00; G06F 13/12

(52) U.S. Cl. 710/17; 710/62

(57) ABSTRACT

An electronic device that connects to external devices through a plurality of interfaces can operate efficiently according to the type of interface connected to the external device. An electronic device has a plurality of interfaces that can connect to a host computer; an external device interface that is connected to an external device; and an output unit that outputs data for external output received from the host computer to the external device interface. The output unit can form a plurality of output channels that output the data for external output received from the host computer to the external device interface.

### CROSS-REFERENCE TO RELATED APPLICATION

Priority is claimed under 35 U.S.C. §119 to Japanese Application No. 2010-207745 filed on Sep. 16, 2010, which is hereby incorporated by reference in its entirety.

### BACKGROUND

1. Technical Field

The present invention relates to an electronic device connected to an external device, to a control method for the electronic device, and to a program.

2. Related Art

Electronic devices that can connect to other external devices through a plurality of interfaces, including USB, are known from the literature. See, for example, Japanese Unexamined Patent Appl. Pub. JP-A-2007-271861.

Knowing what device is connected to which interface can be complicated in an electronic device that connects to other external devices through multiple interfaces as described in JP-A-2007-271861. This can make it difficult for the electronic device to efficiently communicate information by using the particular characteristics of the interface connected to the external device.

### SUMMARY

An electronic device according to the invention connects to external devices through a plurality of interfaces, and can operate efficiently according to the type of interface connected to the external device.

A first aspect of the invention is an electronic device having a plurality of interfaces that can connect to a host computer; an external device interface that is connected to an external device; and an output unit that can form a plurality of output channels for outputting data for external output received from the host computer to the external device interface.

Further preferably, the electronic device has a control unit that receives control data sent from the host computer and operates based on the received control data, detects through the output unit to which of the plural interfaces the host computer is connected, and based on the result selects one of the plural output channels.

The invention can thus detect which of the plural interfaces the host computer is connected to, and based on the result select an output channel that outputs data sent from the host computer to another external device. As a result, the appropriate output channel can be selected for outputting data to the external device and the output method can be optimized according to the characteristics of the interface to which the host computer is connected. Differences in the type or characteristics of the interface can therefore be used to enable efficient processing when data for external output received from the host computer is passed to an external device.

An electronic device according to another aspect of the invention also has a main circuit board having the control unit and the interface connected to the control unit, and an expansion board that can be removably connected to the main circuit board and has at least one interface. The control unit detects through the output unit whether the host computer is connected to the main circuit board interface or to the interface of the expansion board, and based on the result selects the output channel.

This aspect of the invention detects whether the host computer is connected to the interface of the main circuit board or the interface provided on the expansion board removably connected to the main circuit board, and based on the result selects the output channel for outputting the data for external output output from the host computer to the external device. Because the data output method can thus be changed when the host computer is connected to the main circuit board and when the host computer is connected to the expansion board, differences in the type and characteristics of the interfaces can be used for efficient processing. For example, when multiple expansion boards having different types of interfaces are available and expansion boards are swapped and replaced as needed, an output channel that is optimized for the characteristics of the interface provided by the expansion board can be used. In addition, even when an expansion board is not connected to the main circuit board, data for external output sent from a host computer connected to the main circuit board can be output on an output channel appropriate to the interface provided by the main circuit board.

In an electronic device according to another aspect of the invention, the external device interface is disposed on the main circuit board in addition to the control unit and the interface . When the control unit detects through the output unit that the host computer was connected to the interface of the expansion board, the control unit selects an output channel that passes the data for external output sent from the host computer to the external device interface without inputting the data for external output to the control unit . When the control unit detects that the host computer is connected to the interface of the main circuit board, the control unit selects an output channel that inputs the data for external output received from the host computer to the control unit and outputs from the control unit to the external device interface.

This aspect of the invention can output data to an external device without involving processing by the control unit on the main circuit board because data can be passed through from the host computer connected to the interface of the expansion board to the external device connected to the external device interface . In addition, when the host computer is connected to the interface of the main circuit board, the capabilities of the control unit on the main circuit board can be used to efficiently output data to an external device.

In an electronic device according to another aspect of the invention, the output unit outputs data received from the interface of the expansion board to both the control unit disposed to the main circuit board and the external device interface based on the attributes of the data by means of an output channel that passes data for external output through to the external device interface.

When data is passed through from a host computer connected to the interface of the expansion board to an external device connected to the external device interface, this aspect of the invention outputs the data received from the host computer to both the control unit and the external device interface based on the attributes of the data. As a result, data for external output can be output from the host computer to the external device without involving any processing by the control unit. In addition, data to be processed by the control unit can be input to the control unit whether or not an external device is connected. As a result, data input from a host computer can be efficiently transferred and appropriately processed with minimal control.

In an electronic device according to another aspect of the invention, the control unit has a function that converts the data for external output received from the host computer to a signal format appropriate to the external device interface.

This aspect of the invention changes the signal format when outputting data for external output from the control unit to the external device interface, and can therefore efficiently output data for external output according to the specifications of the external device interface, for example.

In an electronic device according to another aspect of the invention, the electronic device is configured as a recording device that is connected to a display device as the external device, outputs display data received from the host computer to the external device interface, and receives and records data sent from the host computer. This aspect of the invention can efficiently transfer data for external output to the display device according to the characteristics of the interface to which the host computer is connected, and can print efficiently based on the data received from the host computer.

Another aspect of the invention is an electronic device control method that controls an electronic device having a plurality of interfaces that can connect to a host computer, and an external device interface connected to an external device, the control method including steps of: receiving control data sent from the host computer and operating based on the received control data; and controlling formation of a plurality of output channels that output data for external output sent from the host computer to the external device interface.

Further preferably, the electronic device control method also has a step of the host computer detecting to which of the plural interfaces the host computer is connected, and based on the result selecting one of the plural output channels.

By executing the control method according to this aspect of the invention, the electronic device can detect which of the plural interfaces the host computer is connected to, and based on the result select an output channel that outputs data sent from the host computer to another external device. As a result, the appropriate output channel can be selected for outputting data to the external device and the output method can be optimized according to the characteristics of the interface to which the host computer is connected. Differences in the type or characteristics of the interface can therefore be used to enable efficient processing when data for external output received from the host computer is passed to an external device.

Another aspect of the invention is a computer-readable storage medium storing a program that can be executed by a control unit that controls an electronic device having a plurality of interfaces that can connect to a host computer, and an external device interface connected to an external device, the program including steps of: receiving control data sent from the host computer and operating based on the received control data; and controlling formation of a plurality of output channels that output data for external output sent from the host computer to the external device interface.

Further preferably, the program also has a step of: the host computer detecting to which of the plural interfaces the host computer is connected, and based on the result selecting one of plural output channels that output data for external output received from the host computer to the external device interface.

By executing the program according to this aspect of the invention, the control unit can detect which of the plural interfaces the host computer is connected to, and based on the result select an output channel that outputs data sent from the host computer to another external device. As a result, the appropriate output channel can be selected for outputting data to the external device and the output method can be optimized according to the characteristics of the interface to which the host computer is connected. Differences in the type or characteristics of the interface can therefore be used to enable efficient processing when data for external output received from the host computer is passed to an external device.

### Effect of the Invention

When an electronic device transfers data for external output sent by a host computer to an external device, the electronic device optimizes the method of outputting data to the external device and processes data efficiently according to the characteristics of the interface to which the host computer is connected.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the configuration of a POS terminal system according to a preferred embodiment of the invention.

FIG. 2 shows an example of switching (selecting) the output channel.

FIG. 3 shows an example of switching (selecting) the output channel.

FIG. 4 shows another example of switching (selecting) the output channel.

FIG. 5 schematically describes signal input/output in the output circuit.

FIG. 6 schematically describes signal input/output in the output circuit.

### DESCRIPTION OF EMBODIMENTS

A preferred embodiment of the present invention is described below with reference to the accompanying figures.

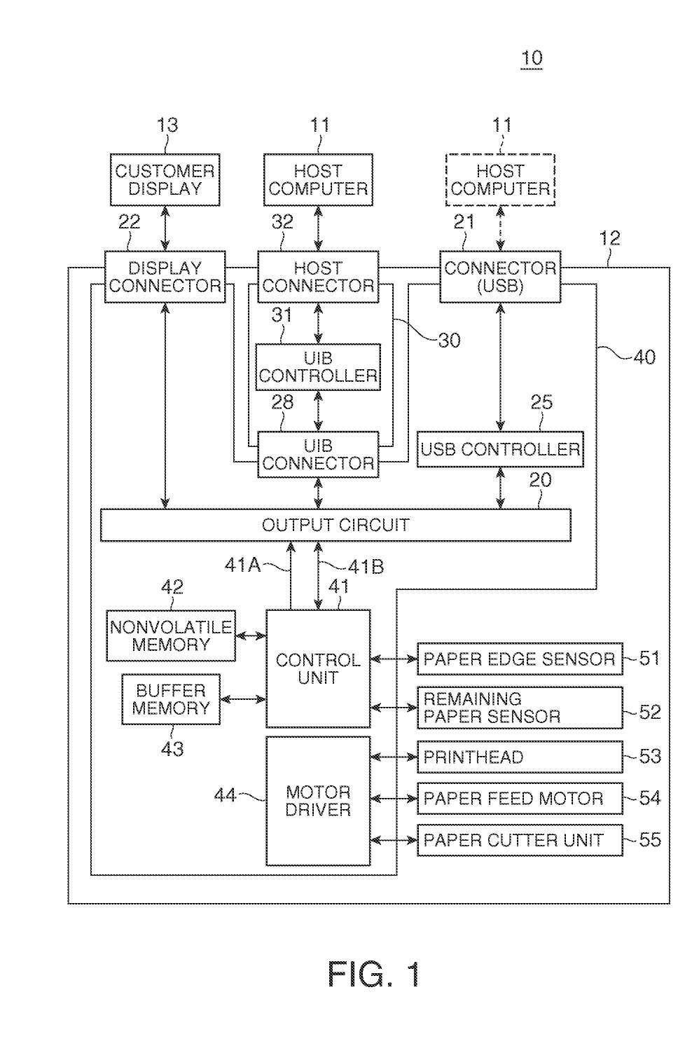

FIG. 1 is a block diagram showing the basic configuration of a POS terminal system 10 according to this embodiment of the invention.

The POS terminal system 10 is a terminal device that is installed in retail stores, for example, and processes sales transactions, and has functions for registering what products are sold, processing payments and disbursements, issuing receipts, tallying sales, and managing inventory, for example. The POS terminal system 10 is connected through a communication network to a POS server (not shown in the figure), sends daily and monthly report data, for example, to the POS server, and receives data including product management data that is sent from the POS server.

The POS terminal system 10 is connected to a host computer 11 that controls operations of the POS terminal system 10, a printer 12 as an example of an electronic device that is connected to the host computer 11 and performs printing processes such as printing receipts and coupons, and a customer display 13 that is connected to the printer 12 and displays information as an example of an external device that is controlled by the host computer 11 through the printer 12.

The printer 12 is connected to the host computer 11 as the control device, and based on data (control data) input from the host computer 11 prints (records) text, images, or other markings on a recording medium. The printer 12 in this embodiment of the invention is described as a thermal printer that stores thermal roll paper as the recording medium inside the printer, forms text, images, or other markings by applying heat to the recording surface of the thermal roll paper by means of a printhead 53 with heating elements, and prints receipts issued by the POS terminal system 10.

The printer 12 includes a control unit 41 that operates as a print engine controlling print operations while also centrally controlling other parts of the printer 12; nonvolatile memory 42 that stores data and programs executed by the control unit 41; buffer memory 43 that temporarily stores data received from the host computer 11; and a motor driver 44 that controls the drive unit of the printer 12 to print. A paper edge sensor 51 and remaining paper sensor 52 are also connected to the control unit 41. The nonvolatile memory 42 is more specifically rendered by a semiconductor storage device such as an EEPROM or flash memory device. The buffer memory 43 is a volatile storage device that stores commands and data input to the control unit 41 in the order received.

The printer 12 includes a printhead 53 that prints on thermal roll paper, a paper feed motor 54 that causes the paper feed roller (not shown in the figure) to turn and convey the thermal roll paper, and a paper cutter unit 55 that cuts the thermal roll paper after printing is completed.

The motor driver 44 is connected to the paper feed motor 54 and paper cutter unit 55 of the printer 12. The motor driver 44 outputs drive current and drive pulses to the paper feed motor 54 to convey the thermal roll paper a necessary amount, and outputs drive current to the paper cutter unit 55 to cut the thermal roll paper at a specific timing.

The paper edge sensor 51 connected to the control unit 41 detects if thermal roll paper is present on the thermal roll paper conveyance path, and the remaining paper sensor 52 detects when the remaining amount of thermal roll paper goes below a specific amount. Both sensors output to the control unit 41.

The control unit 41 executes a program read from nonvolatile memory 42. Based on commands and data stored in buffer memory 43 and the detection values output from the paper edge sensor 51 and remaining paper sensor 52, the control unit 41 drives the head driver (not shown in the figure) connected to the printhead 53, controls energizing the heat elements, and controls the motor driver 44 to operate the paper feed motor 54 and paper cutter unit 55 to print on the thermal roll paper.

The control unit 41, nonvolatile memory 42, buffer memory 43, and motor driver 44 are mounted on a main circuit board 40. The main circuit board 40 is the main circuit board of the printer 12, and interfaces connected to the host computer 11 and customer display 13 are also provided on the main circuit board 40 in addition to the control unit 41 and other devices noted above.

More specifically, a connector 21 (interface) rendering a USB interface connected to the host computer 11, a display connector 22 (external device interface) connected to the customer display 13, and a USB controller 25 connected to connector 21, are also disposed to the main circuit board 40.

Connector 21 is a connector that conforms to the USB (Universal Serial Bus) standard, and the USB controller 25 is a USB device controller conforming to the USB standard.

The USB controller 25 is configured to function as a slave device of the host computer 11 when connected to the USB controller (not shown in the figure) of the host computer 11.

The display connector 22 is a connector connected to the customer display 13. The customer display 13 exchanges signals with the printer 12 using the RS-232C standard. Because the display connector 22 transmits signals according to this standard, the customer display 13 and printer 12 are connected by two lines, a line for outputting display data from the printer 12 to the customer display 13, and a line for outputting error signals from the customer display 13 to the printer 12. The display connector 22 has a power supply line for supplying power from the printer 12 to the customer display 13.

Connector 21 and display connector 22 are exposed to the outside of the side or back of the printer 12 case, and a host computer 11 and customer display 13 can be connected by a cable at any time to the connector 21 and display connector 22.

A UIB connector 28 is also provided on the main circuit board 40. The UIB connector 28 is a connector that is connected to an expansion board 30. In other words, the expansion board 30 can be connected and disconnected from the main circuit board 40 through the UIB connector 28. A host connector 32 (interface) connected to the host computer 11, and a UIB controller 31 connected to the host connector 32, are mounted on the expansion board 30.

Plural expansion boards 30 with different types of host connectors 32 can be connected to the printer 12. Such expansion boards 30 could, for example, have a serial RS-232C interface, an IEEE-1284 interface (a parallel interface), or a USB interface.

For example, an expansion board 30 with an RS-232C interface has a 9-pin D-sub or 25-pin host connector 32, and a UIB controller 31 configured as a serial interface circuit. An expansion board 30 with an IEEE-1284 interface has a Centronics 36-pin connector as a host connector 32, and a parallel communication interface circuit as a host connector 32.

An expansion board 30 with a USB interface has a 4-pin (USB 1.0, 1.1, 2.0) or 9-pin (USB 3.0) 32, and a UIB controller 31 that connects this host connector 32 to the USB controller 25. The expansion board 30 compatible with this USB interface connects the host computer 11 to the control unit 41 using a function of the USB controller 25 mounted on the main circuit board 40.

The display connector 22, USB controller 25, and UIB connector 28 are connected to the control unit 41 through the output circuit 20 (output unit) . The output circuit 20 connects the display connector 22 and the control unit 41, the USB controller 25 and the control unit 41, and the UIB connector 28 and the control unit 41, and enables signal and data I/O between the control unit 41 and customer display 13, data I/O between the USB controller 25 and control unit 41, and data communication between the expansion board 30 and control unit 41. The output circuit 20 can also connect the display connector 22 to the UIB connector 28. Switching which components are connected in the output circuit 20 can be controlled by the control unit 41.

The control unit 41 communicates signals and data through the output circuit 20 with the connector 21, display connector 22, or host connector 32 by sending and receiving communication data 41B through the output circuit 20. The communication data 41B includes, for example, print data from the host computer 11 to the control unit 41, display data (data for external output) output from the host computer 11, control signals sent and received by the host computer 11 and control unit 41, and display data converted by the control unit 41.

Through the output circuit 20, the control unit 41 can also determine if a customer display 13 is connected to the display connector 22, if an expansion board 30 is connected to the UIB connector 28, and the type of interface provided by the expansion board 30 connected to the UIB connector 28. In addition, the control unit 41 can detect if a host computer 11 is connected to the connector 21 using a function of the USB controller 25, and whether a host computer 11 is connected to the host connector 32 of the expansion board 30.

The control unit 41 also outputs a switching control signal 41A for changing (selecting) the internal connection state of the output circuit 20 to the output circuit 20 based on whether or not a customer display 13 is connected, the type of expansion board 30, and whether the host computer 11 is connected to connector 21 or host connector 32. The connection state inside the output circuit 20, that is, the data output channel, is switched according to this switching control signal 41A.

The information displayed on the customer display 13 is information that is processed or generated by the host computer 11, such as product price information, sale quantities, and the sale total. Customer display 13 operation is limited to simply receiving and displaying the display data output from the host computer 11.

Because both the host computer 11 and customer display 13 are connected to the printer 12 as described above, display data output from the host computer 11 to the customer display 13 is first input to the printer 12, and is then output from the printer 12 to the customer display 13.

Because the customer display 13 uses a RS-232C connector, the printer 12 sends RS-232C signals to the customer display 13. If the display data input from the host computer 11 to the printer 12 already conforms to the RS-232C standard, the display data can be passed directly through to the display connector 22 and displayed on the customer display 13 without additional processing. However, if the display data input from the host computer 11 to the printer 12 is not an RS-232C signal, the control unit 41 must convert the signal (data) format for output to the customer display 13.

More specifically, when an expansion board 30 having a RS-232C compatible host connector 32 and UIB controller 31 is connected to the host computer 11, the printer 12 can simply pass the display data through to the customer display 13. The processing load is reduced in this case because the control unit 41 does not need to convert the signal, and information can be displayed efficiently on the customer display 13.

If the host computer 11 is connected to the connector 21, or to an expansion board 30 that is compatible with an interface other than the RS-232C interface, the display data is converted by the control unit 41 and output to the customer display 13. As a result, based on the type of interface to which the host computer 11 is connected, the output circuit 20 in this embodiment of the invention switches between the output channel that passes display data directly through to the customer display 13, and an output channel that outputs to the customer display 13 after the control unit 41 converts the signal format of the display data. This operation is described below.

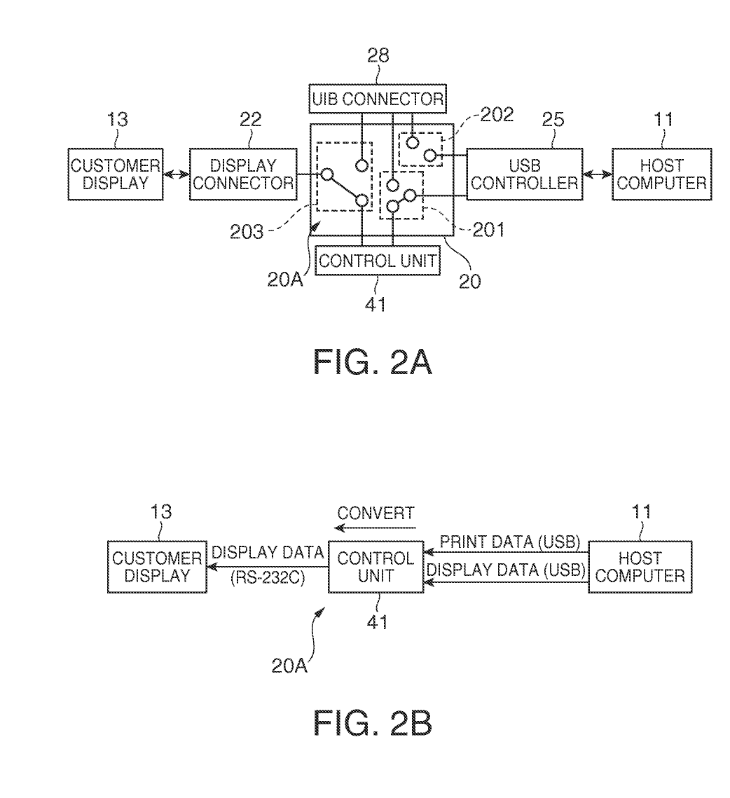

FIG. 2 to FIG. 4 show examples of switching the output channel in the output circuit 20. FIG. 2A and FIG. 2B show a configuration in which the host computer 11 is connected to the USB controller 25 through the connector 21 (connector 21 not shown in the figures), FIG. 2A showing the connection state in the output circuit 20, and FIG. 2B describing the output channels when connected as shown in FIG. 2A.

The output circuit 20 has virtual (logical) switches 201 to 203.

Switch 201 is a switch that selectively connects USB controller 25 and UIB connector 28 to the control unit 41.

Switch 202 is a switch that connects and disconnects the USB controller 25 and UIB connector 28.

Switch 203 is a switch that selectively connects control unit 41 and UIB connector 28 to the display connector 22.

These switches 201 to 203 are controlled by a switching control signal 41A (FIG. 1) output thereto from the control unit 41.

Note that the switches 201 to 203 switch a logical path for data I/O, and can be rendered by transistors or other circuit devices, or by using circuits or memory switches and software that realize the same connection states as the switches 201 to 203 described above. The actual configuration of the output circuit 20 can be determined as desired.

In the example shown in FIG. 2A, the customer display 13 is connected to the display connector 22. In this example, the host computer 11 is connected to the USB controller 25 through connector 21 (not shown in FIG. 2A), and data is input through the USB controller 25 to the control unit 41. As a result, switch 201 connects USB controller 25 and control unit 41, and switch 202 is open. Because data including print data and display data is input in a format compatible with the USB signal format from the host computer 11 in this example, the input display data cannot be output directly to and displayed on the customer display 13. Because the display data input to the control unit 41 is therefore first converted by the control unit 41 to a format that can be displayed by the customer display 13 and is then output to the display connector 22, the switch 203 connects the control unit 41 to the display connector 22. Output channel 20A is formed in the output circuit 20 in this situation. As shown in FIG. 2B, output channel 20A is a channel whereby the print data and display data output from the host computer 11 in a format compatible with the USB interface is input to the control unit 41, the control unit 41 converts the display data to a RS-232C compatible format and outputs the converted display data, and the display data output by the control unit 41 is input to the customer display 13. Furthermore, because both print data and display data from the host computer 11 are input to the control unit 41, the control unit 41 extracts the print data, and controls the motor driver 44, paper edge sensor 51, remaining paper sensor 52, printhead 53, paper feed motor 54, and paper cutter unit 55 to print.

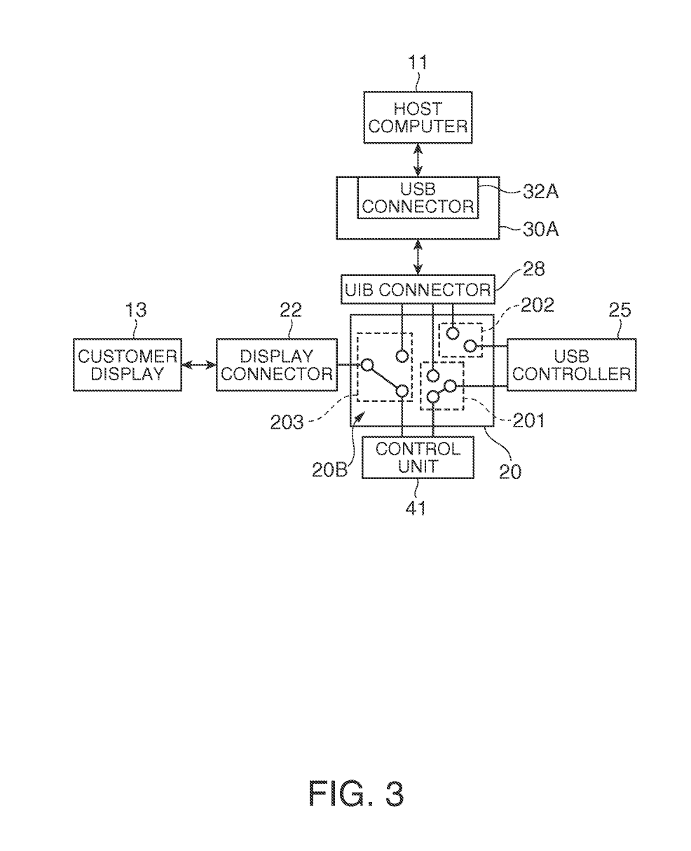

FIG. 3 shows an example in which an expansion board 30A with a USB connector 32A for a USB interface is installed to the UIB connector 28, and the host computer 11 is connected to this USB connector 32A.

In the example shown in FIG. 3, an expansion board 30A with connector 21 and a separate USB connector 32A is connected to the UIB connector 28 as an example of a removable expansion board 30. The data input to the USB connector 32A is controlled by a function of the USB controller 25. This configuration is cost advantageous because there is no need to provide a separate USB controller for the USB connector 32A.

Because the USB controller 25 controls the print data and display data output by the host computer 11 to the expansion board 30A in the configuration shown in FIG. 3, the UIB connector 28 and USB controller 25 are connected by switch 202. Because the print data and display data controlled by the USB controller 25 are input to the control unit 41, switch 201 connects the control unit 41 and the USB controller 25 as shown in FIG. 2A. In addition, because the display data converted by the control unit 41 is output to the display connector 22, switch 203 connects the control unit 41 to the display connector 22.

The output channel 20B formed by the output circuit 20 in this case is the same as output channel 20A (FIG. 2A and FIG. 2B) except the host computer 11 is connected through the UIB connector 28.

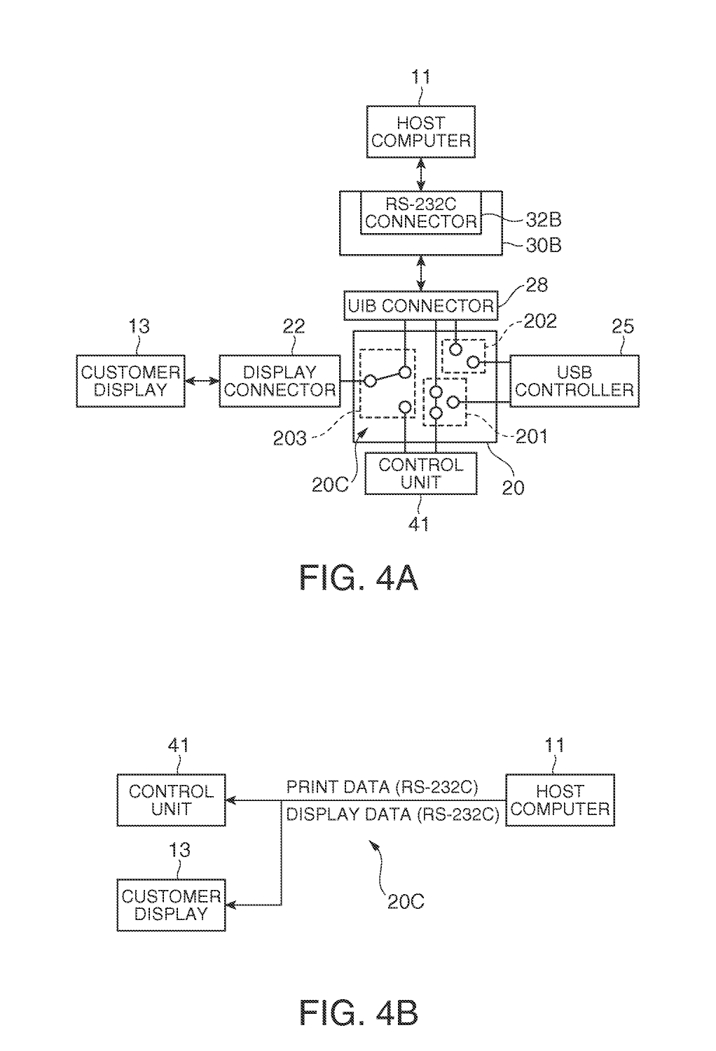

In the example shown in FIG. 4A and FIG. 4B, an expansion board 30B with an RS-232C connector 32B conforming to the RS-232C standard is installed to the UIB connector 28, and the host computer 11 is connected to this RS-232C connector 32B.

In the example in FIG. 4A and FIG. 4B, expansion board 30B is connected to the UIB connector 28 as a type of expansion board 30 that can be removably installed, and the host computer 11 outputs print data and display data that are RS-232C compatible. The print data and display data are controlled by an interface circuit (not shown in the figure) included on the expansion board 30B, and input to the control unit 41. Because the RS-232C display data is also compatible with the customer display 13, it can be input directly to and displayed by the customer display 13. The output circuit 20 in this case forms an output channel 20C that passes the display data input from the host computer 11 to the expansion board 30B directly to the customer display 13.

More specifically, switch 201 connects the UIB connector 28 to the control unit 41, and switch 203 connects UIB connector 28 to the display connector 22. As a result, the same data is sent from the UIB connector 28 to both the control unit 41 and the display connector 22. In addition, switch 202 disconnects the USB controller 25 and the UIB connector 28.

As shown in FIG. 4B, RS-232C compatible print data and display data are input from the host computer 11 to both the control unit 41 and customer display 13.

The output circuit 20 can thus switch between output channels 20A, 20B, and 20C by changing the switching states of switches 201 to 203 as controlled by the control unit 41. It is therefore possible to switch between an output channel 20C that passes data through to the customer display 13, and output channels 20A, 20B enabling the control unit 41 to convert the data format, according to how the host computer 11 is connected and the data format (signal format) output by the host computer 11. The processing load of the control unit 41 can therefore be reduced when pass-through data transfers are possible. In addition, by knowing that data will be converted by the control unit 41, a host computer 11 can be connected to an interface that conforms to a different standard than the customer display 13. For example, the host computer 11 can connect through a USB interface that is faster than an RS-232C interface. The host computer 11 and customer display 13 can therefore connect through a variety of interfaces, and data can be processed efficiently according to the type of interface connecting the devices.

The switch 202 of the output circuit 20 connects the UIB connector 28 and USB controller 25 when the host computer 11 is connected through the UIB connector 28 to a USB interface as shown in FIG. 3. As a result, switch 202 automatically turns ON only when a host computer 11 is connected through the UIB connector 28 to a USB interface, and otherwise remains OFF.

When the USB controller 25 controls communication with the host computer 11, switch 201 connects the USB controller 25 to the control unit 41, and otherwise connects the UIB connector 28 to the control unit 41. In addition, when the USB controller 25 controls communication with the host computer 11, switch 203 connects the control unit 41 to the display connector 22 in order to input data processed by the control unit 41 to the display connector 22 as shown in FIG. 2A and FIG. 3.

However, when data is passed through from the UIB connector 28 to the display connector 22 as described with reference to FIG. 4A and FIG. 4B, the switch 203 connects the UIB connector 28 to the display connector 22. Therefore, switches 201 and 203 can switch in conjunction with each other based on whether or not the host computer 11 is connected to the USB controller 25.

For example, when the host computer 11 is connected to the USB controller 25, the switching control signal 41A goes HIGH and is otherwise LOW, and the switch 201 and switch 203 can be switched by the switching control signal 41A. In this configuration, switch 201 connects the USB controller 25 to the control unit 41 when the switching control signal 41A is HIGH (FIG. 2A), and when the switching control signal 41A is LOW, connects the UIB connector 28 to the control unit 41 (FIG. 4A). Switch 203 connects the control unit 41 to the display connector 22 when the switching control signal 41A is HIGH (FIG. 2A), and when the switching control signal 41A is LOW, connects the UIB connector 28 to the display connector 22 (FIG. 4A). In other words, the output circuit 20 switches to output channels 20A, 20B when the switching control signal 41A is HIGH, and to output channel 20C when the switching control signal 41A is LOW. The output channel can therefore be switched according to how the host computer 11 is connected by using a two-state switching control signal 41A.

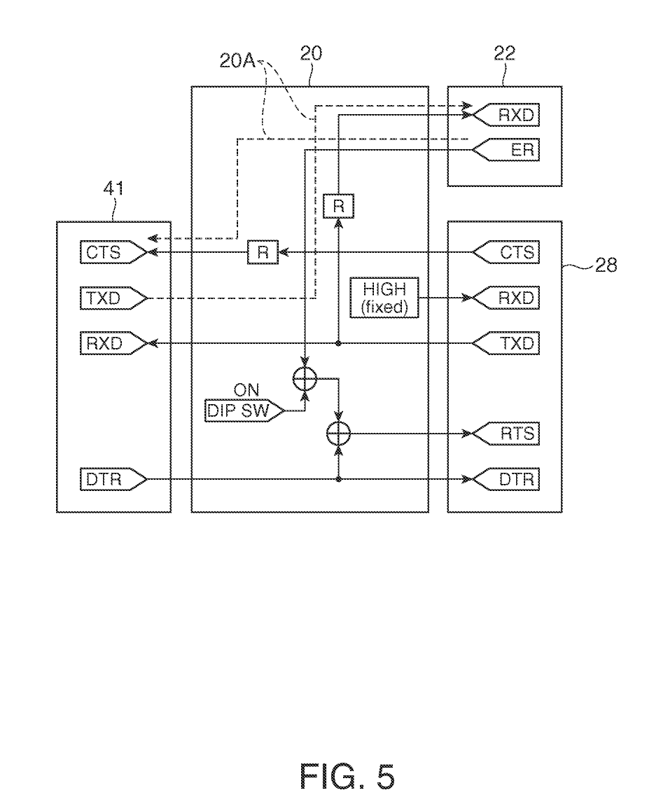

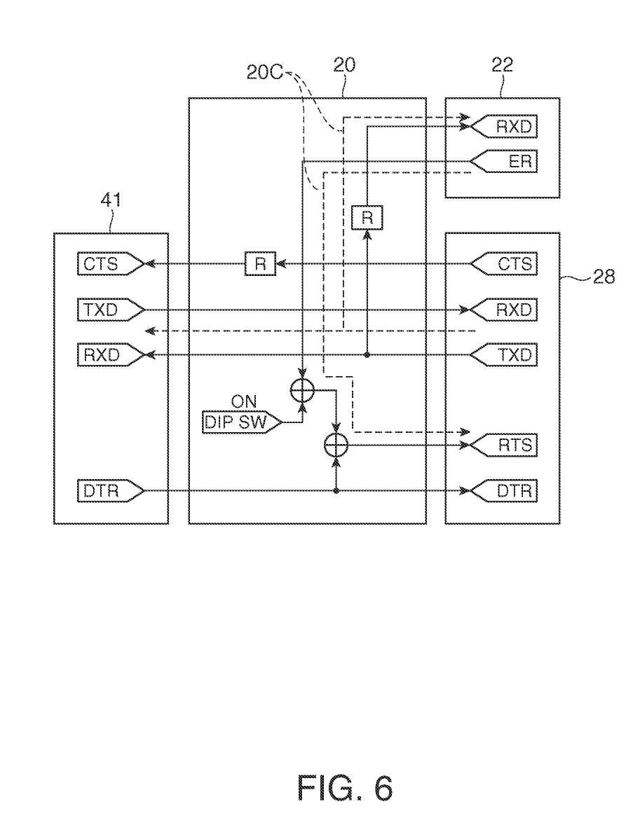

FIG. 5 and FIG. 6 schematically describe the signal I/O states of the output circuit 20. FIG. 5 shows output channel 20A, and FIG. 6 shows output channel 20C. FIG. 5 and FIG. 6 show an example in which the UIB connector 28 has RS-232C signal lines. The states shown in FIG. 5 and FIG. 6 simply show one example of the signal I/O states of the connectors in this POS terminal system 10, and do not limit the actual connections of the output channels 20A to 20C shown in FIG. 2 to FIG. 4.

As shown in FIG. 2A, when the host computer 11 is connected to the USB controller 25 through the connector 21, the control unit 41 is not connected to the UIB connector 28, and an output channel 40A whereby data is input from the USB controller 25 to the control unit 41 is formed.

In this case, as shown in FIG. 5, a signal that is fixed HIGH is output to the RxD (Received Data) pin of the UIB connector 28, and data is not input from the TxD (Transmitted Data) pin of the UIB connector 28. Signals from the control unit 41 are also not sent to the CTS (Clear To Send) pin of the UIB connector 28.

As a result, as shown in FIG. 2A, the output channel 20A that connects the control unit 41 to the display connector 22 is formed in the output circuit 20. As a result, a ready signal corresponding to a ready-to-receive state of the customer display 13 is input from the ER (terminal ready) pin of the display connector 22 to the CTS pin of the control unit 41. Based on this ready signal, display data is output from the TxD pin of the control unit 41 to the RxD pin of the display connector 22.

In addition, as shown in FIG. 4A, when the host computer 11 is connected to the UIB connector 28 through expansion board 30B described above, the output channel 20C connecting the UIB connector 28 to the control unit 41, and the UIB connector 28 to the display connector 22, is formed.

In this case, as shown in FIG. 6, the CTS pin of the UIB connector 28 and the CTS pin of the control unit 41 send the clear to send signal to each other, and data can be communicated between the TxD and RxD pins of the UIB connector 28 and the RxD and TxD pins of the control unit 41. In addition, data output from the TxD pin of the UIB connector 28 is also passed through to the RxD pin of the display connector 22. If the DIP switch is ON, the signal output from the ER pin of the display connector 22 is input to the RTS (Request To Send) pin of the UIB connector 28. When the customer display 13 is connected to the display connector 22, this DIP switch is turned ON by the operator, for example. Signals from the DTR (Data Terminal Ready) pin of the control unit 41 are also input to the DTR pin of the UIB connector 28.

With the configuration shown in FIG. 6, all data (print data and display data) input to the UIB connector 28 is input to both the RxD pin of the display connector 22 and the RxD pin of the control unit

As described above, a printer 12 according to a preferred embodiment of the invention has a connector 21 and a host connector 32 that can connect to a host computer 11; a display connector 22 that is connected to a customer display 13; a control unit 41 that receives print data as control data sent from the host computer 11 and prints based on the received print data; and an output circuit 20 that has plural output channels and outputs display data as data for an external device received from the host computer 11 to the display connector 22 . The control unit 41 detects whether the host computer 11 is connected through the output circuit 20 to the connector 21 or host connector 32, and based on the result selects output channels 20A, 20B or output channel 20C to output the display data received from the host computer 11 to the display connector 22.

As a result, because the output channel 20A, 20B, 20C changes according to whether the host computer 11 is connected to connector 21, and or the host computer 11 is connected to USB connector 32A or RS-232C connector 32B, the output channel and the method of outputting data to the customer display 13 can be optimized according to the characteristics of the interface to which the host computer 11 is connected. As a result, display data sent from the host computer 11 and relayed to the customer display 13 can be efficiently processed using differences in the transmission rate and signal format of the USB interface and RS-232C interface, for example, or using the same type of interface as a customer display 13 that uses an RS-232C interface.

The printer 12 has a control unit 41, a main circuit board 40 with an interface connected to the control unit 41, and an expansion board 30 that has at least one communication interface and is removably installed to the UIB connector 28 of the main circuit board 40. The control unit 41 determines through the output circuit 20 whether the host computer 11 is connected to the connector 21 of the main circuit board 40 or an interface of the expansion board 30, and based on the result switches to the output channels 20A, 20B that output the display data to the display connector 22, or to output channel 20C.

As a result, the data processing method, including whether the control unit 41 converts the data format, can be changed by changing the data output channel according to whether the host computer 11 is connected to the main circuit board 40, or the host computer 11 is connected to the expansion board 30. For example, a plurality of expansion boards 30A, 30B having different types of interfaces could be prepared and the expansion boards 30A, 30B swapped as needed to enable using an output channel optimized for the characteristics of the USB connector 32A and RS-232C connector 32B of the expansion boards 30A, 30B. In addition, display data sent from the host computer 11 can be output through the main circuit board 40 to output channel 20A or output channel 20B even when a expansion board 30 is not connected to the UIB connector 28.

A display connector 22 is also disposed to the main circuit board 40 of the printer 12, and the control unit 41 switches to the output channel 20C that passes display data sent from the host computer 11 to the display connector 22 when the control unit 41 detects that the host computer 11 is connected to the RS-232C connector 32B of expansion board 30B through the output circuit 20, and switches to the output channel 20A that inputs display data sent from the host computer 11 to the control unit 41 and outputs from the control unit 41 to the display connector 22 when the control unit 41 detects that the host computer 11 is connected to the connector 21 of the main circuit board 40.

As a result, data can be output to the customer display 13 without imposing on the processing capacity of the control unit 41 because data is passed through to the customer display 13 from a host computer 11 connected to the RS-232C connector 32B.

In addition, when the host computer 11 is connected to the connector 21, the control unit 41 can be used to efficiently output data to the customer display 13.

Because in this configuration the output circuit 20 of the printer 12 can output data received from the RS-232C connector 32B to both the control unit 41 and the display connector 22 based on attributes of the received data by means of an output channel 20C that passes display data through to the display connector 22, display data can be output from the host computer 11 to the customer display 13 without going through the control unit 41. In addition, data to be processed by the control unit 41 regardless of whether a customer display 13 is connected can be input to the control unit 41. As a result, data input form the host computer 11 can be efficiently transferred and appropriately processed with minimal control intervention.

The invention is described above with reference to a preferred embodiment, and it will be obvious to one with ordinary skill in the related art that the invention is not so limited.

For example, in the embodiment described above the printer 12 is described as using the interfaces of a USB connector 21, a RS-232C display connector 22, a USB connector 32A, and a RS-232C connector 32B, but the invention is not so limited. More particularly, the number and types of interfaces are not specifically limited, and an IEEE-1394 interface, a LAN interface such as a 10/100BASE-T or 1000BASE-TX, or a wireless interface, for example, could be used.

Yet further, the electronic devices to which the invention can be applied could be any type of printer that can control the printing speed on the recording medium, including dot impact printers, inkjet printers, dye sublimation printers, and laser printers. The invention can also be applied to printers that are incorporated in other devices, and is not limited to any particular type.

The foregoing embodiment describes a printer as an example of an electronic device, but the invention can be used with any electronic device having a communication controller and a plurality of interfaces for connecting an external host computer. More specifically, the invention can also be applied to hard disk drives, optical disk recording devices, and other types of devices.

The processes performed by the printer 12 (electronic device) described in the foregoing embodiment can also be embodied as a program. In addition, the program can be provided stored on a storage medium such as an optical disc, magneto-optical disc, or flash memory.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. An electronic device comprising:
a plurality of interfaces that can connect to a host computer;
an external device interface that is connected to an external device; and
an output unit that outputs data for external output received from the host computer to the external device interface, and can form a plurality of output channels that output the data for external output received from the host computer to the external device interface.

2. The electronic device described in claim 1, further comprising:
a control unit that receives control data sent from the host computer and operates based on the received control data,
detects through the output unit to which of the plural interfaces the host computer is connected, and based on the result selects one of the plural output channels.

3. The electronic device described in claim 2, further comprising:
a main circuit board having the control unit and the interface connected to the control unit; and
an expansion board that can be removably connected to the main circuit board and has at least one interface;
wherein the control unit detects through the output unit whether the host computer is connected to the main circuit board interface or to the interface of the expansion board, and based on the result selects the output channel.

4. The electronic device described in claim 3, wherein:
the external device interface is disposed on the main circuit board in addition to the control unit and the interface; and
when the control unit detects through the output unit that the host computer was connected to the interface of the expansion board, the control unit selects an output channel that passes the data for external output sent from the host computer to the external device interface without inputting the data for external output to the control unit.

5. The electronic device described in claim 3, wherein:
the external device interface is disposed with the control unit and the interface to the main circuit board; and
when the control unit detects through the output unit that the host computer is connected to the interface of the main circuit board, the control unit selects an output channel that inputs the data for external output received from the host computer to the control unit and outputs from the control unit to the external device interface.

6. The electronic device described in claim 4, wherein:
the output unit outputs data received from the interface of the expansion board to both the control unit disposed to the main circuit board and the external device interface based on the attributes of the data by an output channel that passes data for external output through to the external device interface.

7. The electronic device described in claim 5, wherein:
the control unit has a function that converts the data for external output received from the host computer to a signal format appropriate to the external device interface.

8. The electronic device described in claim 1, wherein:
the electronic device is configured as a recording device that is connected to a display device as the external device, outputs display data received from the host computer to the external device interface, and receives and records data sent from the host computer.

9. An electronic device control method that controls an electronic device having a plurality of interfaces that can connect to a host computer, and an external device interface connected to an external device, the control method comprising steps of:
receiving control data sent from the host computer and operating based on the received control data; and
controlling formation of a plurality of output channels that output data for external output sent from the host computer to the external device interface.

10. The electronic device control method described in claim 9, further comprising a step of:
the host computer detecting to which of the plural interfaces the host computer is connected, and based on the result selecting one of the plural output channels.

11. The electronic device control method described in claim 9, wherein:
the electronic device has a main circuit board with the interface, and an expansion board that can be removably installed to the main circuit board and has at least one interface;
the control method further comprising a step of the host computer detecting whether the host computer is connected to the interface of the main circuit board or the interface of the expansion board, and selecting the output channel accordingly.

12. The electronic device control method described in claim 11, wherein:
the main circuit board has an external device interface in addition to the interface;
the control method further comprising a step of selecting an output channel that passes the data for external output sent from the host computer to the external device interface without being input to the control unit when the host computer is detected to be connected to the interface of the expansion board.

13. The electronic device control method described in claim 11, wherein:
the main circuit board has an external device interface in addition to the interface;
the control method further comprising a step of selecting an output channel that inputs the data for external output received from the host computer to the control unit and outputs from the control unit to the external device interface when the host computer is detected to be connected to the interface of the main circuit board.

14. The electronic device control method described in claim 12, wherein:
the output unit outputs data received from the interface of the expansion board to both the control unit disposed to the main circuit board and the external device interface based on the attributes of the data by an output channel that passes data for external output through to the external device interface.

15. The electronic device control method described in claim 14, further comprising a step of:
converting the data for external output received from the host computer to a signal format appropriate to the external device interface.

16. A computer-readable storage medium storing a program that can be executed by a control unit that controls an electronic device having a plurality of interfaces that can connect to a host computer, and an external device interface connected to an external device, the program including steps of:
receiving control data sent from the host computer and operating based on the received control data; and
controlling formation of a plurality of output channels that output data for external output sent from the host computer to the external device interface.

17. The computer-readable storage medium described in claim 16 storing a program that further comprises a step of:
the host computer detecting to which of the plural interfaces the host computer is connected, and based on the result selecting one of the plural output channels.
